(19) United States
(12) Patent Application Publication
(10) Pub. No.: US 2026/0275130 A1
(43) Pub. Date: Sep. 17, 2026

(54) RADIATIVE COOLING PAINTS COMPRISING DIFFERENT SIZED BASO4 PARTICLES

(71) Applicant: King Fahd University of Petroleum and Minerals, Dhahran (SA)

(72) Inventors: Muhammad MANSHA, Dhahran (SA); Shahid ALI, Dhahran (SA); Deema Mohammed MARWAHI, Jubail (SA); Safyan Akram KHAN, Dhahran (SA)

(73) Assignee: King Fahd University of Petroleum and Minerals, Dhahran (SA)

(21) Appl. No.: 19/081,914

(22) Filed: Mar. 17, 2025

(51) Int. Cl. C09D 7/61; C08K 3/30; C09D 5/44; C09D 7/40

(52) U.S. Cl. CPC C09D 7/61; C08K 3/30; C09D 5/4411; C09D 7/67; C09D 7/68; C09D 7/69; C08K 2003/3045

(57) ABSTRACT

A radiative cooling paint for passive cooling comprises barium sulfate powder, binder and water. The BaSO₄ powder includes particles in different hydrodynamic size distributions, with an assortment of average particle sizes in the range of about 45 nm to about 1650 nm. Surfaces coated with these paints have a maximum solar reflectance of about 98% and have temperatures as low as 29° C. when exposed to solar radiation for a period of 1 hour. A method for preparation of radiative cooling paints is further described, wherein BaSO₄ particles in different hydrodynamic size distributions are obtained by ball milling process.

### BACKGROUND

### Technical Field

The present disclosure is directed to radiative cooling paints, particularly to sprayable radiative cooling paints comprising barium sulfate (BaSO₄) particles in different sizes. These formulations, having a high refractive index and low solar absorption, are cost-effective and efficient in passive cooling.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Increasing temperatures and frequent heatwaves drive up the demand for energy-intensive cooling options. One preferred cooling options is the use of an air conditioner. In regions facing high to very high temperatures in summers such as South Asia, Africa and countries in the Middle East including Saudi Arabia, there is an increasing use of air conditioners which further results in excessive demand for electricity. According to data collected from various weather prediction and forecasting organizations, the temperature in Riyadh, Kingdom of Saudi Arabia, and many other nearby localities has increased by more than 3° C. in the last 40 years [See: N. Howarth, N. Odnoletkova, T. Alshehri, A. Almadani, A. Lanza, T. Patzek, Staying Cool in A Warming Climate: Temperature, Electricity and Air Conditioning in Saudi Arabia, Climate. 8 (2020) 4]. This situation is compounded by the fact that Saudi Arabia currently ranks as the world's third-largest electricity consumer for air conditioning systems. Air conditioning systems alone contribute to over 50% of the total annual electricity consumption in buildings. During peak cooling demands, this figure surges to nearly 70%, establishing Saudi Arabia as the foremost user of air conditioning worldwide [See: KAPSARC (King Abdullah Petroleum Studies and Research Center), The Future of Cooling in Saudi Arabia: Technology, Market and Policy Options, 2020.]. However, the increasing use of air conditioning not only results in large consumption of electricity but also contribute to greenhouse gas emissions, leading to climate change and proportional increase in temperatures.

Increased solar energy absorption also leads to an increase in surface temperatures resulting in enhanced power consumption as approximately 53% of solar energy falls within the thermal infrared range of the electromagnetic spectrum, spanning wavelengths from 700 nm to 2500 nm [See: V. and N. E. R Subasri, A., Kavitha, A L., Devadoss, Economical Development of IR Coatings in Asbestos Sheet, Int. J. Curr. Res. Life Sci. 7 (2018) 2062-2066]. Consequently, reducing solar radiation-induced heating in buildings is imperative to mitigate power consumption. Passive daytime radiative cooling (PDRC) is one way for reducing energy consumption and mitigating the urban heat island effect which is particularly important in the context of global warming and climate change. PDRC includes the use of specific coatings or materials designed to passively cool surfaces by reflecting solar radiation and emitting excess heat into space through the infrared atmospheric transparency window. In several cooling applications, radiative cooling has shown great promise in lowering the cost of space cooling. It also has the potential to cut energy consumption and fight climate change. Low-emissive paints or coatings, which offer high reflectivity or low emissivity in the thermal infrared portion of the spectrum, are thus passive, practical, and cost-effective options [See: O. Dayal, S., Dubey, A., Dixit, A. K. and Dev, Study of Polymer Binders to Develop Low Emissive Paints for Thermal Radiation Management Applications, Indian J. Pure Appl. Phys. 4 (2022) 347-353]. However, the practical implementation of PDRC materials with both low cost and high solar band reflectivity continues to face commercialization hurdles, as their solar reflectance levels remain significantly lower [See: O. Dayal, S., Dubey, A., Dixit, A. K. and Dev, Study of Polymer Binders to Develop Low Emissive Paints for Thermal Radiation Management Applications, Indian J. Pure Appl. Phys. 4 (2022) 347-353; C. Wang, X. Wu, F. Wang, X. Zhang, Optimization Design of a Multilayer Structure for Broadband and Direction-Selective Emissivity, ES Energy Environ. (2021)].

To minimize solar absorption in the UV region, the investigation of many alternative materials with electron band gaps higher than 4.13 eV is being conducted [See: X. Li, J. Peoples, P. Yao, X. Ruan, Ultrawhite BaSO₄ Paints and Films for Remarkable Daytime Sub-ambient Radiative Cooling, ACS Appl. Mater. Interfaces. 13 (2021) 21733-21739; John Pockett and Martin Belusko, A Review of Heat-reflective Paints, in: Solar2010, 48th AuSES Annu. Conf., the 48th AuSES Annual Conference, Canberra, Australia, 2010]. Such materials may include titanium dioxide (TiO₂), aluminum oxide (Al₂O₃) and silicate-based coatings. However, it has been reported that amongst the coatings of TiO₂, BaSO₄, SiO₂, or CaCO₃ [See: Z. Cheng, Y. Shuai, D. Gong, F. Wang, H. Liang, G. Li, Optical properties and cooling performance analyses of single-layer radiative cooling coating with mixture of TiO₂ particles and SiO₂ particles, Sci. China Technol. Sci. 64 (2021) 1017-1029; X. Li, J. Peoples, Z. Huang, Z. Zhao, J. Qiu, X. Ruan, Full Daytime Sub-ambient Radiative Cooling in Commercial-like Paints with High Figure of Merit, Cell Reports Phys. Sci. 1 (2020) 100221], TiO₂-based coatings suffer low particle concentration where the 3.2 eV electron band gap of TiO₂ leads to its high solar absorptivity in the ultraviolet band [See: X. Li, J. Peoples, P. Yao, X. Ruan, Ultrawhite BaSO₄ Paints and Films for Remarkable Daytime Sub-ambient Radiative Cooling, ACS Appl. Mater. Interfaces. 13 (2021) 21733-21739]. Dong et al. used the combination of BaSO₄ (7.6 eV) and CaCO₃ (6 eV) with a high electron band gap to achieve low solar absorptivity [See: John Pockett, Heat reflecting paints and a review of their advertising material, Barton, A. C. T., Hilton Adelaide, South Australia, 2010.].

Further, efficient radiative cooling pigments demand a high refractive index (n) and low extinction coefficient (k) in the solar spectrum. However, neither of these optical characteristics can be tuned independently because they are well correlated to the electronic band gap. For instance, eliminating ‘k’ would require a high band gap, yielding low ‘n’, creating an impasse to address radiative cooling. According to the broadband characteristics of solar radiation, solar reflection can be enhanced by using a wide particle-size distribution. Smaller particles are better at scattering light, which enhances solar reflectance. However, if the particles are too small, they may agglomerate, leading to reduced performance whereas larger particles may not scatter light as efficiently. Therefore, optimizing the particle size distribution is essential to achieve a balance between effective light scattering and stability, ultimately improving the cooling performance of the coatings. Existing radiative cooling compositions comprise materials with varying particle sizes and such materials are shown to have enhanced solar reflectance.

U.S. Pat. No. 11,084,944B2 describes a radiative cooling paint comprising an acrylic polymer binder and mixed particles sizes in the range of 0.1 μm to 5 μm. The particles may be of PTFE, barium sulfate, zinc oxides, aluminum oxides, magnesium oxides, TiO₂ and the paint may have a solar reflectance up to 97%. The solar reflector particles may have a distribution of sizes and morphologies, such as flakes and spheres.

CN117328567A describes a reflective coating which can reflect more than 97% of the solar radiation heat by relying on its high reflectivity and high atmospheric window emissivity, which includes nano-barite with a particle size distribution of 90 nm to 250 nm and a polyacrylic acid organic solvent. An alternate formulation has a particle size distribution is 90 nm to 550 nm and the weight ratio of the two is 1.8:1.

US20210403726A1 describes a solar-reflective infrared-emissive paint having barium sulfate nanoparticles in an acrylic polymeric matrix that contains 60% volume percent of 500 nm barium sulfate nanoparticles. The paint has a very high solar reflectance of about 98.1% and a high sky window emissivity of 95%. The average particle size is chosen as 500 nm to reflect both the visible and near infrared range of solar irradiation.

US20240026202A1 describes a sub-ambient daytime radiative cooling (SDRC) coating comprising an alkali activated metakaolin, BaSO₄, and silica nanospheres which has an infrared emissivity of 0.93-0.9491 between 8 nm to 13 nm and has 97.6% solar reflectance. The composition can achieve sub-ambient cooling up to 8.9° C. under direct sunlight.

Dual layer systems comprising nanoparticle-based radiative cooling paint at a top layer and a cellulose-based substrate at a bottom layer are being investigated for their cooling potential and mechanical strength. [See: Andrea Felicelli et. al. Efficient radiative cooling of low-cost BaSO4 paint-paper dual-layer thin films. Nanophotonics. 2024 Jan. 23; 13 (5): 639-648)]. In this paper, a multilayer film with a 125 μm layer of paint, consisting of 60% concentration barium sulfate nanoparticles in an acrylic matrix was coated evenly over the commercial white cotton paper. BaSO4-acrylic paints were chosen for their ease of application and a total solar reflectance of 98.1% was reported.

A bilayer structured coating for passive daytime sub-ambient radiative cooling is also reported [See: Wan, Rongbing; Ma, Zhihao; Xu, Weiping; Zhao, Wenbo; Xu, Jingtao search by orcid; Yang, Ronggui. Bilayer structured coating for radiative cooling applications. Journal of Photonics for Energy, Volume 11, id. 042109 (2021)]. The bilayer radiative cooling coating, described in this research has a high solar reflectance of about 0.94 and high infrared emissivity of about 0.96 in the atmospheric window. The bilayer coating is reported to achieve a sub-ambient temperature of 3.6° C. under solar irradiance of 990 W/m² at an ambient temperature of 26.6°. The coating comprises TiO₂ and BaSO₄ used in a bottom layer and a top layer in which the BaSO₄ is about 1 micron.

Each of the aforementioned references describe radiative formulations with barium sulfate particles in different sizes but within a limited distribution range. It has been observed that the particle volume, concentration, and particle size distribution of the radiative cooling material in a wide range has a significant impact on the light scattering phenomenon and the overall solar reflectance when compared to a uniform particle size distribution.

Accordingly, it is one object of the present disclosure to provide radiative cooling paints that would minimize solar absorption with a high refractive index and facilitate strong scattering. Another object of the present disclosure is to provide cost-effective radiative cooling paints comprising barium sulfate particles in a wide size distribution range that can achieve a solar reflectance of at least 98% for the purpose of mitigating the urban-island effect.

### SUMMARY

In an exemplary embodiment, a sprayable radiative cooling paint is described. The paint comprises about 25 wt. % polyacrylic binder; about 50 wt. % deionized water; and about 25 wt. % BaSO₄ particles having a plurality of hydrodynamic size distributions between about 45 nm to about 1,650 nm as determined by dynamic light scattering (DLS) measurements, wherein a first hydrodynamic size distribution has an average particle size from 1,600 nm to 1,650 nm, a second hydrodynamic size distribution has an average particle size from 300 nm to 350 nm, a third hydrodynamic size distribution has an average particle size from about 175 nm to 190 nm, a fourth hydrodynamic size distribution has an average particle size from 145 nm to 160 nm, a fifth hydrodynamic size distribution has an average particle size from 130 nm to 140 nm and a sixth hydrodynamic size distribution has an average particle size from 45 nm to 60 nm, wherein wt. % is based on a total weight of the sprayable radiative cooling paint.

In another exemplary embodiment, a method of making a sprayable radiative cooling paint is described. The method comprises obtaining a first quantity of BaSO₄ powder having a hydrodynamic size distribution with an average particle size of about 1638 nm; grinding, in a ball milling machine, a second quantity of BaSO₄ powder for about two hours until the second quantity has a second hydrodynamic size distribution with an average particle size of about 326 nm; grinding, in a ball milling machine, a third quantity of BaSO₄ powder for about six hours until the third quantity has a third hydrodynamic size distribution with an average particle size of about 183 nm; grinding, in a ball milling machine, a fourth quantity of BaSO₄ powder for about ten hours the fourth quantity has a fourth hydrodynamic size distribution with an average particle size of about 151 nm; grinding, in a ball milling machine, a fifth quantity of BaSO₄ powder for about twenty-four hours until the fifth quantity has a fifth hydrodynamic size distribution with an average particle size of about 137 nm; grinding, in a ball milling machine, a sixth quantity of BaSO₄ powder for about forty-eight hours until the sixth quantity has a sixth hydrodynamic size distribution with an average particle size of about 53 nm is obtained; and forming a first sprayable radiative cooling paint, a second sprayable radiative cooling paint, a third sprayable radiative cooling paint, a fourth sprayable radiative cooling paint and a fifth sprayable radiative cooling paint by mixing, in a mixer, in an amount of about 25 wt. %, combinations of each of the first quantity of BaSO₄ powder, the second quantity, the third quantity, the fourth quantity, the fifth quantity and the sixth quantity, respectively, with about 25 wt. % of polyacrylic binder and about 50 wt. % of deionized water, ultrasonicating, in an ultrasonicator, each sprayable radiative cooling paint and mixing, by a roller mixer, each sprayable radiative cooling paint for about twenty-four hours.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of making a radiative cooling paint, according to certain embodiments.

FIG. 2 illustrates preparation steps for passive daytime radiative cooling (PDRC) coating and various ratios of BaSO₄ particles, according to certain embodiments.

FIG. 3 shows X-ray diffraction (XRD) patterns of BaSO₄ samples after ball milling for 0 h, 2 h, 6 h, 10 h, 24 h and 48 h at 400 rpm, according to certain embodiments.

FIG. 4 shows dynamic light scattering (DLS) particle size distributions of BaSO₄ samples after ball milling for 0 h, 2 h, 6 h, 10 h, 24 h, and 48 h, according to certain embodiments.

FIG. 5A shows field emission scanning electron microscopy (FESEM) of representative BaSO₄ samples milled for 0 h, according to certain embodiments.

FIG. 5B shows FESEM of representative BaSO₄ samples milled for 2 h, according to certain embodiments.

FIG. 5C shows FESEM of representative BaSO₄ samples milled for 24 h, according to certain embodiments.

FIG. 5D shows FESEM of representative BaSO₄ samples milled for 48 h, according to certain embodiments.

FIG. 6 shows ultraviolet-visible-near infrared (UV-VIS-NIR) solar reflectance of BaSO₄ particles based PDRC coatings, according to certain embodiments.

FIG. 7 shows a sample exposed to a solar simulator, according to certain embodiments.

FIG. 8 shows temperature performance comparison of various formulations under the solar simulator, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

A weight percent of a component is based on the total weight of the formulation or composition in which the component is included. For example, if a particular element or component in a composition or article is said to have 5 wt. %, it is understood that this percentage is in relation to a total compositional percentage of 100%.

As used herein, “particle size” may be considered the diameters, lengths or longest dimensions of a particle.

As used herein, “hydrodynamic size” refers to an apparent size of a particle in a fluid. It is also termed as “hydrodynamic diameter” which is the effective diameter of a particle in a fluid, as determined by its movement and interactions with the surrounding medium.

As used herein, “radiative paints”, “radiative formulations” or “radiative coatings” are used interchangeably and refer to compositions that have high thermal emittance and solar reflectance.

Aspects of this disclosure are directed to a cost-effective and efficient radiative-cooling paint formulation which achieves maximum light scattering by utilizing an optimized combination of different sizes of BaSO₄ particles. The use of different sized particles of BaSO₄ as filler with a paint has been investigated for their potential to minimize solar absorption with a reasonably high refractive index and to facilitate strong scattering leading to greater reflections [See: J. Mandal, Y. Yang, N. Yu, A. P. Raman, Paints as a Scalable and Effective Radiative Cooling Technology for Buildings, Joule. 4 (2020) 1350-1356]. According to the present disclosure, BaSO₄ particles were reduced by a ball-milling technique for 0, 2, 4, 6, 8, 10, 24, and 48 hours at a speed of 400 rpm to reduce the BaSO₄ particles to an assortment of sizes. The DLS, XRD, and FESEM analysis were used to characterize and determine the particle sizes of ground materials. DLS analysis showed that the size of particles decreased from about 1.64 μm to 53 nm with increasing ball-milling time (0-48 hours). XRD patterns showed a rise in the broadness of peaks, which reveals a decline in particle size. Additionally, a combination of BaSO₄, a polymeric binder, and deionized water in a 1:1:2 ratio resulted in a homogenously ultra-white coating.

The radiative cooling paints of the present disclosure comprise particles of a material having a high refractive index, a binder and water. Some of the materials known for their high refractive index include titanium dioxide (TiO₂), barium sulfate (BaSO₄), zinc oxide (ZnO), aluminum oxide (Al₂O₃) and the like. In an aspect, barium sulfate is preferred in the formulations of present disclosure. Barium sulfate has a high refractive index and is chemically stable, hence it does not react easily with other components or environmental factors. Further, BaSO₄, due to a high electron band gap, reflects the infrared radiations and has low solar absorption which makes it more effective in cooling down heated surfaces and the surrounding environment. The radiative cooling paints comprise barium sulfate particles in an amount of about 22-25 wt. %, wherein the wt. % is based on a total weight of the radiative cooling paint. In one aspect, the BaSO₄ particles may be present in an amount of about 23 wt. %, about 24 wt. %, about 25 wt. % based on a total weight of the radiative cooling paint.

In an aspect, the radiative cooling paint includes a binder to hold the BaSO₄ particles together. The presence of the binder ensures the formation of a durable and cohesive film of the paint when applied. Binders may be selected based on the type of cooling formulation, other components present in the formulations and the intended application method. Suitable binders in the present formulations include acrylic, epoxy, polyurethane, silicone binders and the like. Acrylic binders may be preferred for their durability, strong adhesion and resistance to environmental factors including UV rays and changing weather conditions. Suitable acrylic binders may be the ones based on monomers like methyl methacrylate, ethyl acrylate, ethyl-hexyl acrylates, styrene and butyl acrylate. In a non-limiting example, polymers based on acrylic binders or their derivatives are used in the present radiative cooling paints. The polyacrylic binders may be present in the paints in an amount of about 22 wt. % to 25 wt. %, wherein the wt. % is based on a total weight of the radiative cooling paint. The polyacrylic binders may be present in an amount of about 23 wt. %, about 24 wt. %, about 25 wt. % based on a total weight of the radiative cooling paint.

The radiative cooling paint, as described herein, includes a solvent for preparing the formulation in a liquid form. In an aspect, the solvent is water. The water may be distilled water, double distilled water, deionized water or reverse osmosis water. The use of deionized water is preferable as the presence of ions in water may affect the reflective and emissive properties of the paint. The amount of deionized water in the paints may be in the range of 48 wt. % to 50 wt. %, based on a total weight of the radiative cooling paint.

In some aspects, the BaSO₄ particles, binder and water may be present in the cooling paint in a ratio of 1:1:2. Accordingly, the paints may comprise BaSO₄ particles in an amount of about 25 wt. %, a binder in an amount of about 25 wt. % and water in an amount of about 50 wt. % based on a total weight of the radiative cooling paint. In a non-limiting example, the paints may comprise BaSO₄ particles in an amount of about 25 wt. %, a polyacrylic binder in an amount of about 25 wt. % and deionized water in an amount of about 50 wt. % based on a total weight of the radiative cooling paint.

The BaSO₄ particles in the cooling paint have a wide particle-size distribution comprising a range of different particle sizes. In fluidic systems, especially colloids, particle sizes alone may not sufficiently elucidate the dynamic interactions between particles and their surrounding fluid medium. In such cases, it is desirable to measure hydrodynamic sizes of particles which can characterize the behavior of the particle more accurately when surrounded by fluids. Hydrodynamic size includes the size of the particle along with the layer of fluid to which it adheres as it moves through the medium. In the present disclosure, the hydrodynamic sizes of particles and the corresponding distribution is determined by a dynamic light scattering (DLS) technique. The radiative cooling paints comprise a plurality of hydrodynamic size distributions ranging from about 45 nm to about 1650 nm. Different hydrodynamic size distributions of particles are obtained by performing ball milling of BaSO₄ for different number of hours. Each such hydrodynamic size distribution includes particles with specific average particle sizes.

In an aspect of the present disclosure, a first hydrodynamic size distribution has an average particle size in the range of about 1600 nm to about 1650 nm. In an aspect, the first hydrodynamic size distribution has an average particle size in the range of about 1602 nm to about 1648 nm, preferably about 1604 nm to about 1646 nm, preferably about 1606 nm to about 1644 nm, preferably about 1608 nm to about 1642 nm, preferably about 1610 nm to about 1640 nm, preferably about 1612 nm to about 1638 nm, preferably about 1614 nm to about 1636 nm, preferably about 1616 nm to about 1634 nm, preferably about 1618 nm to about 1632 nm, preferably about 1620 nm to about 1630 nm, preferably about 1622 nm to about 1628 nm, preferably about 1624 nm to about 1626 nm. In certain aspects, a first hydrodynamic size distribution having an average particle size of about 1638 nm is preferable.

A second hydrodynamic size distribution has an average particle size in the range of about 300 nm to about 350 nm. In an aspect, the second hydrodynamic size distribution has an average particle size of one of about 305 nm, about 310 nm, about 315 nm, about 320 nm, about 325 nm, about 330 nm, about 335 nm, about 340 nm or about 345 nm. A second hydrodynamic size distribution having an average particle size of about 324 nm to about 326 nm is preferable. In an example, the second hydrodynamic size distribution has an average particle size of about 326 nm.

A third hydrodynamic size distribution has an average particle size in the range of about 175 nm to about 190 nm. In some aspects, the average particle size may be any of about 176 nm, about 177 nm, about 178 nm, about 179 nm, about 180 nm, about 181 nm, about 182 nm, about 183 nm, about 184 nm, about 185 nm, about 186 nm, about 187 nm, about 188 nm or about 189 nm. A preferred average particle size may be about 183 nm.

A fourth hydrodynamic size distribution may have an average particle size of about 145 nm. The maximum average particle size herein may be about 160 nm. In some aspects, the fourth distribution may include particles of average particle sizes in the range of about 145 nm to about 160 nm. The fourth distribution may further include particles of average particle sizes in any of the range of 146 nm to 159 nm, the range of 147 nm to 158 nm, the range of 148 nm to 157 nm, the range of 149 nm to 156 nm, the range of 150 nm to 155 nm, the range of 151 nm to 154 nm and in the range of 152 nm to 153 nm.

A fifth hydrodynamic size distribution may have an average particle size in the range of about 130 nm to about 140 nm. The particles may have an average particle size of any of about 131 nm, about 132 nm, about 133 nm, about 134 nm, about 135 nm, about 136 nm, about 137 nm, about 138 nm and about 139 nm.

A sixth hydrodynamic size distribution includes particles of average particle sizes in the range of about 45 nm to about 60 nm. The particles may have average sizes of any of about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm and about 59 nm.

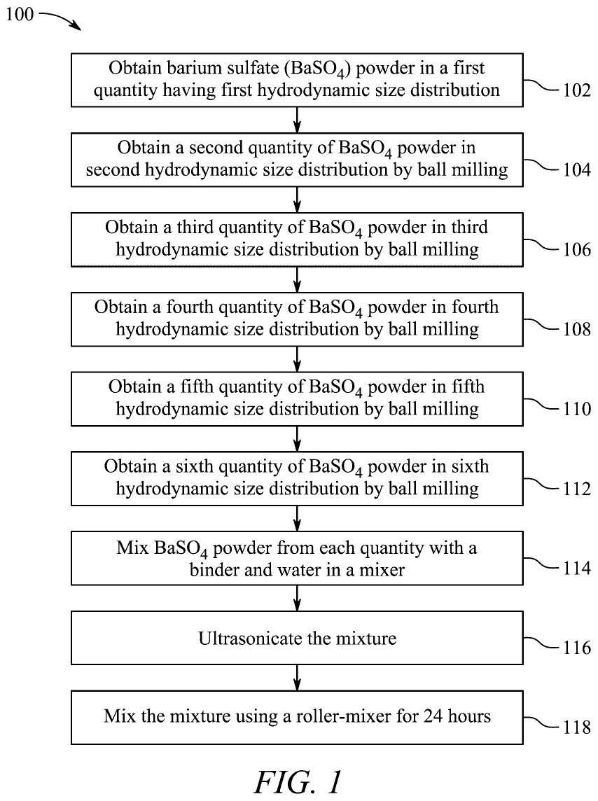

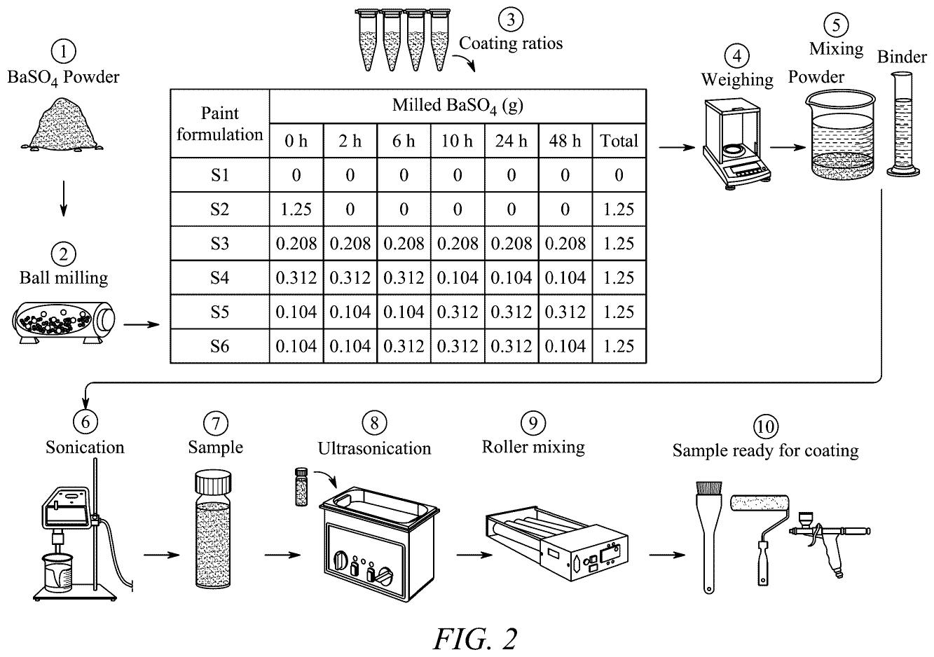

A method 100 for making a radiative cooling paint is further described. A schematic flow chart of the method 100 is shown in FIG. 1 and the method 100 is further illustrated with reference to the process depicted in FIG. 2. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes obtaining barium sulfate (BaSO₄) powder in a first quantity. In one aspect, the particles in the powder may have a specific hydrodynamic size distribution based on the required average particle size. In another aspect, the particles may be present in different hydrodynamic size distributions. The quantity of the BaSO₄ powder may vary based on the type and number of hydrodynamic size distributions of particles present in the paint formulations. In an example, particles in the first hydrodynamic distribution are selected. The average particle size of such particles may be in the range of 1600 nm to 1650 nm. In a non-limiting example, the average particle size may be about 1638 nm.

The first quantity of the BaSO₄ powder may be about 25 wt. % based on a total weight of the radiative cooling paint. In another example, the BaSO₄ powder may have particles in first hydrodynamic size distribution, second hydrodynamic size distribution, third hydrodynamic size distribution, fourth hydrodynamic size distribution, fifth hydrodynamic size distribution and sixth hydrodynamic size distribution. In such formulations, the first quantity of the BaSO₄ powder comprising particles in first hydrodynamic distribution may include amounts of about 2.08 wt. %, about 4.16 wt. % or about 6.24 wt. % based on a total weight of the BaSO₄ particles in the radiative cooling paint.

At step 104, the method 100 includes grinding the BaSO₄ powder in a ball milling machine to obtain a second quantity of BaSO₄ powder. The second quantity preferably has particles in second hydrodynamic size distribution. The particles in various hydrodynamic size distributions can be obtained by ball milling the BaSO₄ powder for a specific time period. Ball milling is performed in a ball milling machine wherein the powder is placed in a rotating cylinder containing a grinding medium such as a ceramic or a metal ball. As the cylinder rotates, the balls collide with the BaSO₄ particles, breaking them down into smaller sizes. The duration and speed of the ball milling process can be adjusted to achieve different hydrodynamic size distributions. In an aspect, ball milling is performed for time periods of about 0 hour, 2 hours, 6 hours, 10 hours, 24 hours and 48 hours to obtain particles of different hydrodynamic size distributions. A speed of about 200 RPM to about 600 RPM is suitable for the ball milling process. In some aspects, ball milling is performed at a constant speed of about 400 RPM for the specified time periods. In an example, ball milling of BaSO₄ powder is performed at the speed of 400 RPM for a period of about 2 hours to obtain particles in second hydrodynamic size distribution.

The second quantity of the BaSO₄ powder may comprise particles in second hydrodynamic distribution. The average particle size of such particles may be in the range of 300 nm to 350 nm. In a non-limiting example, the average particle size of particles in second quantity may be about 326 nm. The second quantity may include particles in amounts of about 2.08 wt. %, about 4.16 wt. % or about 6.24 wt. % based on a total weight of the BaSO₄ particles in the radiative cooling paint.

At step 106, the method 100 includes grinding the BaSO₄ powder in a ball milling machine to obtain a third quantity of BaSO₄ powder containing particles in third hydrodynamic size distribution. The particles in third hydrodynamic size distribution may have an average particle size of about 175 nm to about 190 nm. This particle size is achieved by ball milling the BaSO₄ powder for a period of about six hours. In one aspect, the particles having average particle size of about 183 nm are preferable. The third quantity of particles may comprise particles in amounts of about 2.08 wt. %, about 4.16 wt. % or about 6.24 wt. % based on a total weight of the BaSO₄ particles in the radiative cooling paint.

At step 108, the method 100 includes grinding the BaSO₄ powder in a ball milling machine to obtain a fourth quantity of BaSO₄ powder having particles in fourth hydrodynamic size distribution. The fourth hydrodynamic size distribution includes particles of average particle sizes in the range of about 145 nm to about 160 nm. The BaSO₄ powder is subject to ball milling for a period of about ten hours to obtain particles in fourth hydrodynamic size distribution. The fourth quantity may include particles of average particle sizes of about 151 nm wherein such particles may be present in amounts of about 2.08 wt. %, about 4.16 wt. % or about 6.24 wt. % based on a total weight of the BaSO₄ particles in the radiative cooling paint.

At step 110, the method 100 includes grinding the BaSO₄ powder in a ball milling machine to obtain a fifth quantity of BaSO₄ powder. The fifth quantity contains particles in fifth hydrodynamic size distribution. To obtain particles in fifth hydrodynamic size distribution, ball milling of BaSO₄ powder is performed for a period of about twenty-four hours. The particles in fifth hydrodynamic size distribution have an average particle size of about 130 nm to about 140 nm. In a non-limiting example, the particles may have an average particle size of about 137 nm. The fifth quantity may include particles in amounts of about 2.08 wt. %, about 4.16 wt. % or about 6.24 wt. % based on a total weight of the BaSO₄ particles in the radiative cooling paint.

At step 112, the method 100 includes grinding the BaSO₄ powder in a ball milling machine to obtain a sixth quantity of BaSO₄ powder, wherein the sixth quantity of BaSO₄ powder has particles in sixth hydrodynamic size distribution. The sixth quantity includes particles having an average particle size of about 45 nm to about 60 nm. Particles in the sixth hydrodynamic size distribution may preferably have an average particle size of about 53 nm. To obtain such particles, ball milling of BaSO₄ powder is performed for a period of about forty-eight hours. The sixth quantity of BaSO₄ particles includes amounts of about 2.08 wt. %, about 4.16 wt. % or about 6.24 wt. % based on a total weight of the BaSO₄ particles in the radiative cooling paint.

At step 114, the method 100 includes mixing BaSO₄ powder, binder and water in a mixer wherein the three components are added in amounts of about 25 wt. %, about 25 wt. % and about 50 wt. % respectively. The BaSO₄ powder comprises particles from various hydrodynamic size distributions. Accordingly, the 25 wt. % BaSO₄ powder may comprise particles from one or more of the first quantity, second quantity, third quantity, fourth quantity, fifth quantity, and sixth quantity. In such case, the particles from each quantity collectively make up 25% by weight of the BaSO₄ powder. A uniform mixture of the components is prepared using an ultrasonic mixer, preferably an ultrasonic high shear mixer.

At step 116, the method 100 includes ultrasonicating the mixture for a period of about 5 to 10 min. Ultrasonication can be performed using an ultrasonicator, preferably for a period of about 5 minutes. Ultrasonication helps in dispersion and uniform distribution of particles within the binder and water molecules.

At step 118, the method 100 includes subjecting the mixture to further mixing using a roller-mixer. Any particle agglomerates remaining after ultrasonication may be broken down at this step. Mixing by a roller-mixer also eliminates any air bubbles formed in the mixture resulting in a homogenous and smooth formulation. The mixture is gently mixed on a roller-mixer for a period of about 22 hours to 24 hours. In an example, the mixture is subjected to mixing for a period of about 24 hours. The formulations are dried overnight to obtain the radiative paint coatings of the present disclosure.

One or more radiative cooling paint formulations can be prepared with BaSO₄ particles having different hydrodynamic size distributions. In one aspect, the radiative cooling paint comprises about 25 wt. % of polyacrylic binder, about 50 wt. % of deionized water and about 25 wt. % of BaSO₄ particles wherein the particles are present in the first hydrodynamic size distribution. In a non-limiting example, a radiative cooling paint formulation (S2) is described. S2 comprises about 25 wt. % of polyacrylic binder, about 50 wt. % of deionized water and about 25 wt. % of BaSO₄ particles in the first hydrodynamic distribution wherein the particles have an average particle size of about 1638 nm. Such formulation coatings exhibit a maximum solar reflectance in the thermal infrared spectrum of about 80%. Additionally, when a surface coated with this formulation is exposed to solar radiation for a period of about 1 hour, the temperature of the surface is found to be about 29° C.

In another aspect, the radiative paints may comprise about 25 wt. % of polyacrylic binder, about 50 wt. % of deionized water and about 25 wt. % of BaSO₄ particles wherein the particles may be present in two or more hydrodynamic size distributions. In an example, particles may be present in the second and third hydrodynamic size distributions, in the third and fourth hydrodynamic size distributions, in the fourth and fifth hydrodynamic size distributions or in the fifth and sixth hydrodynamic size distributions. The formulations may contain particles in first, second and third hydrodynamic size distributions, in second, third and fourth hydrodynamic size distributions or third, fourth and fifth hydrodynamic size distributions. Any possible combination of particles in different hydrodynamic size distributions may be included in the present formulations.

In an aspect of the present disclosure, a formulation (S3) comprises about 25 wt. % of polyacrylic binder, about 50 wt. % of deionized water and about 25 wt. % of BaSO₄ particles wherein the BaSO₄ particles are present in all six hydrodynamic distributions. The BaSO₄ particles include about 4.16 wt. % of particles having the first hydrodynamic size distribution with an average particle size of about 1638 nm, about 4.16 wt. % of particles having the second hydrodynamic size distribution with an average particle size of about 326 nm, about 4.16 wt. % of particles having the third hydrodynamic size distribution with an average particle size of about 183 nm, about 4.16 wt. % of particles having the fourth hydrodynamic size distribution with an average particle size of about 151 nm, about 4.16 wt. % of BaSO₄ particles having the fifth hydrodynamic size distribution with an average particle size of about 137 nm, and about 4.16 wt. % of particles having the sixth hydrodynamic size distribution with an average particle size of about 53 nm. The dried coatings of the S3 formulation exhibit a maximum solar reflectance in the thermal infrared spectrum of about 98%. The temperature of surfaces coated with the S3 formulation, when exposed to solar radiation for a period of about 1 hour, is found to be about 27° C.

In an aspect of the present disclosure, a paint formulation (S4) having a solar reflectance in the infrared spectrum of at least about 90% is described. S4 comprises about 25 wt. % of polyacrylic binder, about 50 wt. % of deionized water and about 25 wt. % of BaSO₄ particles wherein the BaSO₄ particles include about 6.24 wt. % of particles having the first hydrodynamic size distribution with an average particle size of about 1638 nm, about 6.24 wt. % of particles having the second hydrodynamic size distribution with an average particle size of about 326 nm, about 6.24 wt. % of particles having the third hydrodynamic size distribution with an average particle size of about 183 nm, about 2.08 wt. % of particles having the fourth hydrodynamic particle size of about 151 nm, about 2.08 wt. % of particles having the fifth hydrodynamic size distribution with an average particle size of about 137 nm, and about 2.08 wt. % of particles having the sixth hydrodynamic size distribution with an average particle size of about 53 nm. Temperature measurements of surfaces coated with S4 formulations, on exposure to solar radiation for a period of about 1 hour, further indicate a higher solar reflectance. The temperature of such surfaces when measured is about 29° C. which is significantly lower than the temperature of surfaces coated with commercially available paints.

In an aspect of the present disclosure, an exemplary radiative cooling paint formulation (S5) comprises about 25 wt. % of polyacrylic binder, about 50 wt. % of deionized water and about 25 wt. % of BaSO₄ particles, wherein the BaSO₄ particles include about 2.08 wt. % of particles having the first hydrodynamic size distribution with an average particle size of about 1638 nm, about 2.08 wt. % of particles having the second hydrodynamic size distribution with an average particle size of about 326 nm, about 2.08 wt. % of particles having the third hydrodynamic size distribution with an average particle size of about 183 nm, about 6.24 wt. % of particles having the fourth hydrodynamic size distribution with an average particle size of about 151 nm, about 6.24 wt. % of particles having the fifth hydrodynamic size distribution with an average particle size of about 137 nm, and about 6.24 wt. % of particles having the sixth hydrodynamic size distribution with an average particle size of about 53 nm.

In an aspect of the present disclosure, an exemplary radiative paint formulation (S6) comprises about 25 wt. % of polyacrylic binder, about 50 wt. % of deionized water and about 25 wt. % of BaSO₄ particles, wherein the BaSO₄ particles include about 2.08 wt. % of particles having the first hydrodynamic size distribution with an average particle size of about 1638 nm, about 2.08 wt. % of particles having the second hydrodynamic size distribution with an average particle size of about 326 nm, about 6.24 wt. % of particles having the third hydrodynamic size distribution with an average particle size of about 183 nm, about 6.24 wt. % of particles having the fourth hydrodynamic size distribution with an average particle size of about 151 nm, about 6.24 wt. % of particles having the fifth hydrodynamic size distribution with an average particle size of about 137 nm, and about 2.08 wt. % of particles having the sixth hydrodynamic size distribution with an average particle size of about 53 nm.

Dried coatings of S5 and S6 formulations exhibit a maximum solar reflectance in the infrared light spectrum of about 90% and about 80% respectively. Further, the temperature of surfaces coated with S5 formulation when exposed to solar radiation for a period of about 1 hour is about 31° C. while surfaces coated with S6 formulations, after exposure to solar radiation for a period of about 1 hour, have a temperature of about 35° C.

The radiative cooling paints may be applied on surfaces where passive cooling is required. In an example, the paints may be applied on external surfaces of buildings such as roofs, walls and the like. Large surfaces may particularly benefit from the cooling paints as their coatings reduce the need for air conditioning. Additionally, they may be used on pavements, parking lots, and even vehicles to help lower temperatures. Other surfaces where these paints may be applied include outdoor equipment and storage tanks, where maintaining cooler temperatures can be crucial for efficiency and safety.

The method of application of the radiative cooling paints can be chosen based on the type and texture of surfaces. The paints can be applied to surfaces by brushing, rolling, or spraying. Accordingly, a suitable form of the paints can be prepared. For example, for large surface areas, such as the roofs of buildings, the paints can be prepared in sprayable form. Brushing and rolling can be preferred for relatively smaller surface areas. The present radiative paints are preferably prepared in sprayable form.

The paints can be applied in a single layer or multiple layers depending on the thickness of the paint formulation. A single thick layer or multiple thin layers can be applied on surfaces for enhanced cooling. However, the thickness of the layers is selected based on the type of surface to be coated. For instance, a very thick layer on a building roof may lead to heat entrapment in the building, and passive cooling may not be effective in such cases.

The radiative paint formulations of the present disclosure are cost-effective when compared to paints comprising TiO₂ and other solar-reflecting materials. These formulations can alleviate the urban-island effect by lowering the temperatures of buildings by spraying or coating surfaces with the formulated paints, thus decreasing the CO₂ footprint from the energy consumed for cooling applications.

### EXAMPLES

The following examples demonstrate radiative cooling paints as described herein. The examples are provided solely for illustration and are not to be construed as limitations of the present disclosure, as many variations thereof are possible without departing from the spirit and scope of the present disclosure.

### Example 1: Methodology for Preparation of PDRC Coatings

### Ball Milling of Commercial BaSO₄ Particles

Six samples of commercial BaSO₄ (10.0 g) were ground by using a ball milling machine (Union Process (HD/HDDM) High Energy Ball Mill) for 0, 2, 6, 10, 24, and 48 h, respectively, at a constant speed of 400 rpm. The samples were separated from the zirconia balls of the machine of 5 mm size using an iron gauge and labeled as Sample 1, Sample 2, Sample 3, Sample 4, Sample 5, and Sample 6 (0 h, 2 h, 6 h, 10 h, 24 h, and 48 h).

### Example 2: Measurement of Hydrodynamic Size of Particles

The dynamic light scattering (DLS) technique was used to analyze the hydrodynamic sizes of all samples. For this purpose, 10 mg of BaSO₄ powder from each ball-milled sample was mixed in 5 mL of deionized (DI) water. The suspension was uniformly dispersed by sonication for two minutes using an ultrasonicator. However, this solution was too concentrated, so 0.5 mL was pipetted out and dispersed with 2 mL of DI water by repeated sonication for 10 minutes, and the sample was examined using DLS. The same methodology was adopted for the remaining samples to measure the hydrodynamic size of BaSO₄ particles.

In a non-limiting example, the ultrasonicator may be the Ultrasonic Processor, UP400St, manufactured by Hielscher Ultrasonics, Teltow, Germany.

### Example 3: X-Ray Diffraction (XRD) Analysis of BaSO₄ Samples

X-ray diffraction (XRD) analyses were carried out using an X-ray diffraction instrument to determine the crystalline phase of BaSO₄ NPs. All BaSO₄ samples (0, 2, 6, 10, 24, and 48 h) were subjected to XRD measurements provided with Cupper Kα X-rays radiation (λ=0.15406 nm) source to see the crystal size of each ball-milled sample. The scan rate was kept at 2°/minute by changing the 20 values from 10° to 70°.

In a non-limiting example, the X-ray diffraction instrument is the Miniflex, manufactured by Applied Rigaku Technologies, Cedar Park, Texas, United States of America.

### Example 4: Field Emission Scanning Electron Microscopy (FESEM) Analysis of BaSO₄ Samples

An FESEM equipped with a focused ion beam (FIB) and energy dispersion spectroscopic (EDS) detector was used to analyze the morphologies of BaSO₄ samples (0, 2, 6, 10, 24, and 48 h) and validate their particle sizes.

Field Emission Scanning Electron Microscopy (FESEM) is a microscope technique that uses electrons to study the surface of an object. It is used to create high-resolution images of the object's topography, including its microstructure, imperfections, and elemental composition. In a non-limiting example, the FESEM is the LYRA-3, manufactured by TESCAN, Kohoutovice, Czech Republic.

### Example 5: Preparation of PDRC Coatings

Different formulations of BaSO₄ particles were prepared by mixing milled samples (Sample 1-Sample 6) with polyacrylic binders. Each mass of BaSO₄ sample was ultrasonicated for 5 minutes with a polyacrylic crystal clear binder. Formulation S1 (Table 2) was prepared by mixing polyacrylic binder (50 wt. %) and DI water (50 wt. %) only, while formulation S2 was made by taking equal amounts of commercial BaSO₄ (25 wt. %) and polyacrylic binder (25 wt. %) with DI water (50 wt. %) as solvent. Formulation S3 was prepared by taking equal amounts of S1-S6 (25 wt. %), polyacrylic binder (25 wt. %), and DI water (50 wt. %). In the case of formulation S4, higher amounts of larger size or lower time milled BaSO₄ particles were used rather than smaller size/higher time ball milled particles, whereas for formulation S5, the amounts are reversed. Lastly, formulation S6 was prepared by using larger masses of intermediate sizes/ball-milled BaSO₄ particles. A high filler volume concentration of about 60% is considered much higher than typical commercial paints to enable strong scattering in the composite. Furthermore, the wide particle size distribution promotes high solar light reflection. After properly labeling all the samples, the vials were closed to secure and mixed gently on a roller mixer for 24 hours. The mixture was completely dried overnight in a mold, resulting in a free-standing sample. The coating samples were then painted on a surface and tested to ensure stability.

In a non-limiting example, the polyacrylic binder is Polyacrylic, The Miniwax Company, Cleveland, Ohio, United States of America.

### Example 6: Testing of PDRC Coatings

The variable particle sizes of BaSO₄ were mixed with polyacrylic binders and different paint formulations to achieve the best scattering.

### Results and Discussions

### Characterization of Ball-Milled BaSO₄ Particles

The present disclosure capitalizes on the principle that photonic structures can be harnessed to amplify solar reflectivity by introducing multiple interfaces with varying dielectric properties, thereby facilitating extensive scattering of solar light. A sprayable formulation was developed by employing BaSO₄ particles ranging from nano to micron scales to scatter a broad spectrum of sunlight encompassing various wavelengths. BaSO₄ material with a specific particle volume, concentration, and particle size distribution considerably affects solar reflection and enhances the overall solar reflectance compared to a uniform particle size distribution. The vital step in executing the idea successfully was to prepare BaSO₄ particles in various size ranges using a top-down milling approach. A commercial BaSO₄ composition was ground using a ball milling machine for a range of hours comprising 0, 2, 6, 10, 24, and 48 hours at a constant speed of 400 rpm to achieve a range of particle size distributions of BaSO₄. The BaSO₄ particles resulting from each ball milling time were collected and labeled as Sample 1-Sample 6, designated as S1-S6, (0 h, 2 h, 6 h, 10 h, 24 h, and 48 h), respectively.

The samples of BaSO₄ particles of different sizes prepared by ball milling were characterized using dynamic light scattering (DLS), XRD, and FESEM analyses. The crystalline phases of different BaSO₄ samples were determined using the XRD pattern obtained, as shown in FIG. 3. All the XRD spectra of BaSO₄ exhibit the crystalline phase structure of orthorhombic shapes are well-matched with the standard pattern of JCPDS NO. JCPDS 1997 [See: M. J. Meagher, B. Leone, T. L. Turnbull, R. D. Ross, Z. Zhang, R. K. Roeder, Dextran-encapsulated barium sulfate nanoparticles prepared for aqueous dispersion as an X-ray contrast agent, J. Nanoparticle Res. 15 (2013) 2146]. Intermediate intensity doublet peaks were observed at 2θ positions 20.46° and 20.95°, while four more intense peaks were seen at 2θ positions of 26.34°, 27.37°, 29.24°, and 42.96° along with other smaller intensity peaks. The existence of the sharpest peaks gives assurance of the presence of high crystallinity. The sharpness of the peaks decreases with a rise in ball milling times, and the peaks become broader.

The results of these experiments can be used to characterize the resulting paint compositions and improve solar reflection, which can be enhanced by using the wide particle-size distribution. As a result, the materials examined are thought to provide a better solution to several environmental problems.

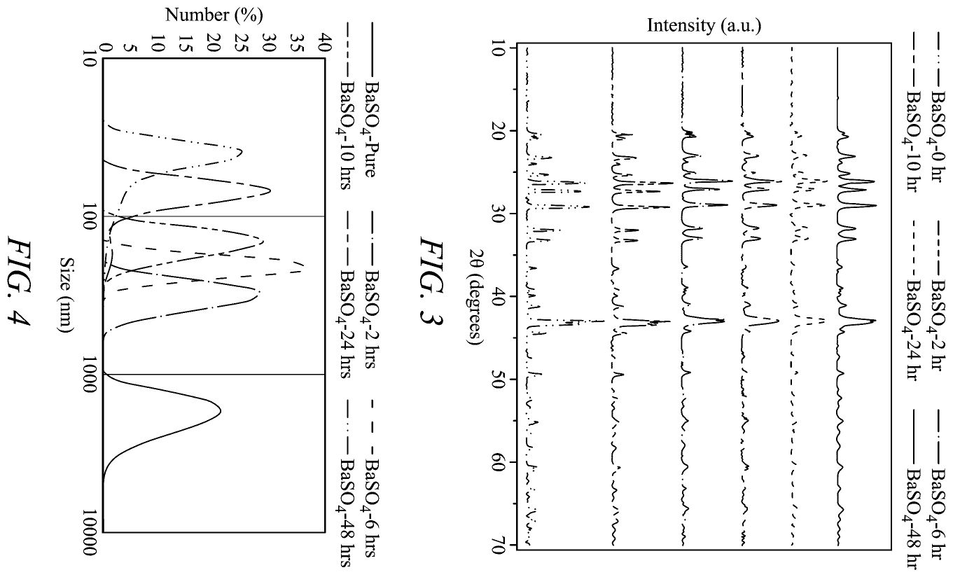

DLS analysis of BaSO₄ particles was carried out to determine the hydrodynamic size of the particles. The results of DLS are provided in Table 1. Further, FIG. 4 shows dynamic light scattering (DLS) particle size distributions of BaSO₄ samples after ball milling for 0 h, 2 h, 6 h, 10 h, 24 h, and 48 h. The size of particles or crystallites decreased from ~1.64 μM to 53 nm on increasing the ball-milling time from 0 to 48 hrs. The broadness of the peaks in the XRD data increased, indicating a decrease in particle size needed to provide multi-size particles in nanocomposites to improve solar reflection and aid in creating passive radiative cooling coatings. DLS measures the size of particles suspended in liquid by measuring temporal fluctuations in the intensity of scattered light that reflects the diffusion of the particles.

TABLE 1
Hydrodynamic and particle sizes of BaSO₄ NPs after ball milling.

| Sample Code | S1 | S2 | S3 | S4 | S5 | S6 |
|---|---|---|---|---|---|---|
| Ball milling time (h) | 0 | 2 | 6 | 10 | 24 | 48 |
| DLS hydrodynamic size nm) | 1638 | 326 | 183 | 151 | 137 | 53 |
| FESEM Particle Size (nm) | 1534 | 329 | — | — | 119 | 83 |

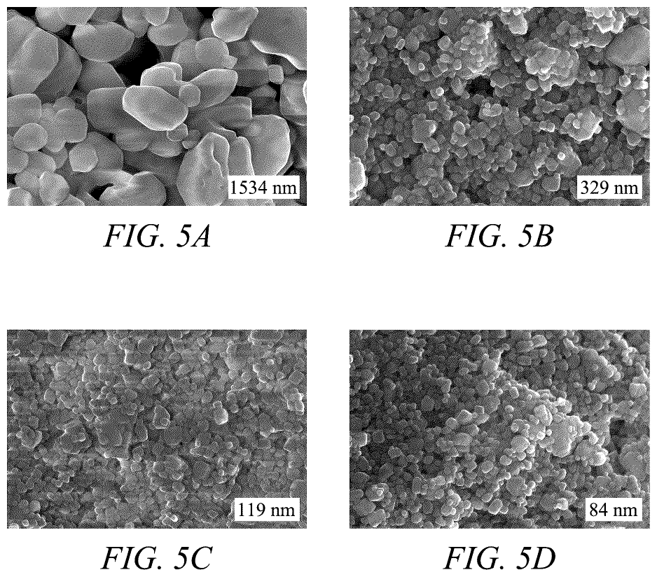

The morphologies and particle sizes of BaSO₄ samples after ball milling were ascertained by FESEM analyses. FIG. 2 shows that only the representative samples milled for 0 h, 2 h, 24 h, and 48 h have been analyzed, and their particle sizes are reported in Table 1. The irregular morphologies ranging from rectangular, square, round, and cylindrical particles for 0 h ball milled sample having an average size of 1534 nm were observed as shown in FIG. 5A. However, after ball milling the samples, the multi-corner spherical shape achieved some uniformity, and the same regular pattern was realized in samples after 2 h, 24 h, and 48 h of milling, only varying with size. FIG. 5B, FIG. 5C, FIG. 5D show results from FESEM of representative BaSO₄ samples milled for 2 h, 24 h, and 48 h. The trend of sizes also confirms that the particle size decreases with increasing the time of ball milling. The comparison of FESEM and DLS results predicts reasonable agreement with FESEM micrographs, as illustrated in Table 1.

Preparation of PDRC Coatings from BaSO₄ Ball-Milled Samples

To prepare various formulations, S1-S6, different combinations of the milled BaSO₄ particles were mixed with deionized water and a single binding agent, i.e., polyacrylic polymer (Miniwax Company, Cleveland, Ohio, USA). To avoid any complication and interference in the result, the use of many other additives was avoided, which generally are part of commercial paints, e.g., anti-foaming agents, gelling agents, multiple binders, dispersants, rheology modifiers, coalescing solvents, etc. Different formulations of BaSO₄ particles were prepared by mixing milled samples (S1-S6) with polyacrylic binder and ultrasonicating for 5 minutes. The formulation S1 was prepared without any BaSO₄ pigments by mixing a polyacrylic binder and DI water to be used as a reference. The other five samples (S2-S6) were formulated with BaSO₄ (1.25 g, 25 wt. %), polyacrylic binder (1.25 g, 25 wt. %), and DI water (2.50 g, 50 wt. %) as solvent (Table 2). For instance, to prepare the S3 formulation, each size of BaSO₄ NPs contributes 4.16 wt. % (0.208 g) to make 25 wt. % (1.25 g). The unique feature of these five samples is that they have different proportions of BaSO₄ with specific particle sizes. The decision to add a specific proportion of each size of milled BaSO₄ was systematic and based on the notion that the broad particle size distribution contributes highly to solar light reflection while the smaller sizes contribute to ultraviolet reflection. All formulated samples were left on the roller mixer for 24 hours to achieve homogeneity by gentle mixing. The mixture was left fully dried overnight in a mold, resulting in a free-standing sample. The coating samples were then painted on a surface and evaluated to ensure stability. Each sample was coated on the glass substrate (glass slides and vials) and dried for 24 hours under the protective glass cage to avoid dust. Then, samples were exposed to a temperature of 60° C. for another 24 hours to observe any visual cracks or imperfections. The thickness of each dried sample was measured with a high-precision ultrasonic digital probe. It was ensured that each dried sample had at least a 200 μm thickness. The recorded thickness for each sample was used to normalize scattering data.

TABLE 2
Formulation of radiative-cooling paint (5 g) using different sizes of
BaSO₄ NPs (25 wt. %), acrylic polymer (25 wt. %), and DI water (50 wt. %).

| Paint | Milled BaSO₄ (g) | | | | | | | Acrylic | Water |
|---|---|---|---|---|---|---|---|---|---|
| Formulation | 0 h | 2 h | 6 h | 10 h | 24 h | 48 h | Total | (g) | (g) |
| S1 | 0 | 0 | 0 | 0 | 0 | 0 | 0 | 2.50 | 2.50 |
| S2 | 1.25 | 0 | 0 | 0 | 0 | 0 | 1.25 | 1.25 | 2.50 |
| S3 | 0.208 | 0.208 | 0.208 | 0.208 | 0.208 | 0.208 | 1.25 | 1.25 | 2.50 |
| S4 | 0.312 | 0.312 | 0.312 | 0.104 | 0.104 | 0.104 | 1.25 | 1.25 | 2.50 |
| S5 | 0.104 | 0.104 | 0.104 | 0.312 | 0.312 | 0.312 | 1.25 | 1.25 | 2.50 |
| S6 | 0.104 | 0.104 | 0.312 | 0.312 | 0.312 | 0.104 | 1.25 | 1.25 | 2.50 |

As illustrated in FIG. 2, the method for preparation of the PDRC coating is divided into three parts. To make the mixed solution, each different combination of the BaSO₄ particles were mixed with the acrylic polymer and the deionized water. The solution was then agitated at 400 r/min for 60 minutes to achieve a uniform suspension. The suspension was then added to the substrate. The coating can be applied by spraying or brushing, and the length of the construction process roughly determines its thickness. The deposited film was then dried for 24 hours at room temperature. It was dried in an oven at 60° C. for 3 hours to speed up and ensure the drying process.

The performance validation is arbitrated by the interaction of particles used in the different formulations with photons for three distinct scattering regions called Raleigh scattering, Mie scattering, and Geometric scattering. The particles in the Mie scattering zone have a wavelength akin to the light and are expected to show forward forward-weighted scattering phase function [See: John Pockett, Heat reflecting paints and a review of their advertising material, Barton, A. C. T., Hilton Adelaide, South Australia, 2010]. Rayleigh scattering is anticipated where the particle is substantially smaller than the wavelength of light, resulting in a more equivalent forward versus backward scattering phase function [See: J. Mandal, Y. Yang, N. Yu, A. P. Raman, Paints as a Scalable and Effective Radiative Cooling Technology for Buildings, Joule. 4 (2020) 1350-1356.]. In the case of geometric scattering, the substantially larger particles than the wavelength of light result in a dominant forward scattering phase function with well-defined restricted backscattering zones [See: M. J. Meagher, B. Leone, T. L. Turnbull, R. D. Ross, Z. Zhang, R. K. Roeder, Dextran-encapsulated barium sulfate nanoparticles prepared for aqueous dispersion as an X-ray contrast agent, J. Nanoparticle Res. 15 (2013) 2146]. The following techniques recorded the analytical record for the performance of each prepared sample.

### UV-Vis NIR Solar Reflectance of BaSO₄ Particles Based PDRC Coatings

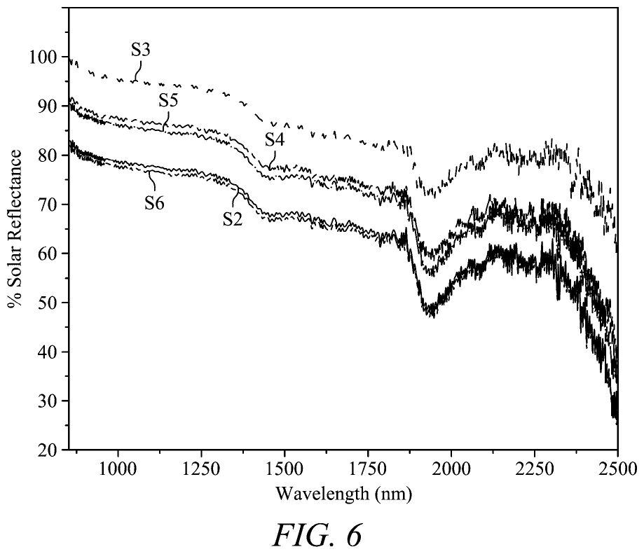

The interaction of sphere-shaped particles with photons gives three distinct scattering regions called Raleigh scattering, Mie scattering, and Geometric scattering. The particles in the Mie scattering zone have a wavelength akin to the light wave and show a forward-weighted scattering phase function [See: S. D. Gedzelman, Optics, Atmospheric|Optical Phenomena, in: Encycl. Atmos. Sci., Elsevier, 2003: pp. 1583-1594]. A Rayleigh scattering zone is detected when a particle is substantially smaller than the wavelength of light, resulting in a forward scattering phase function versus a backward scattering phase function [See: D. L. Andrews, Rayleigh Scattering and Raman Effect, Theory, in: Encycl. Spectrosc. Spectrom., Elsevier, 2017: pp. 924-930]. In the case of Geometric scattering, a particle is much larger than the wavelength of light, resulting in a dominant forward scattering phase function with well-defined restricted backscattering zones [See: A. A. L. Michael I. Mishchenko, Larry D. Travis, Multiple scattering of light by particles: Radiative transfer and coherent backscattering, Cambridge University Press, The PDRC coatings were prepared from different sizes of BaSO₄ particles by mixing with the polyacrylic binder and developed as a homogeneously ultra-white paint employed on glass substrates. UV-vis spectrophotometer reflectance measurements were performed for the NIR region (900-2500 nm) to investigate how different ratios of different particle sizes affect the overall reflectance. The reflectance measured by spectrophotometer showed impressive results for the NIR region of solar reflectance. FIG. 6 shows ultraviolet-visible-near infrared (UV-VIS-NIR) solar reflectance of BaSO₄ particles based PDRC coatings. The formulation S3 having equal amounts (0.208 g, 4.16 wt. %) of all six sizes BaSO₄ (total: 25 wt. %) and polyacrylic binder (1.25 g, 25 wt. %) showed the best results, having a maximum solar reflectance >98% in the infrared region. However, all of the coating formulations (S2-S6) coatings had higher solar reflectance in the near-infrared spectrum than that of the solar reflectance of plain white paint, which has a visible light solar reflectance of about 80% but absorbs ultraviolet (UV) and near-infrared (near-IR) rays, which warm buildings.

These reflectance-based findings support using equal amounts of multi-size particles in nanocomposites to improve solar reflection and create passive radiative cooling coatings. These results also indicate that the combination of different sizes of particles and their appropriate concentrations can broaden the spectral scattering peaks while maintaining a low absorption coefficient, resulting in improved spectral reflectivity across the entire solar spectrum and facilitating a higher total solar reflectance. The addition of small-sized particles from 50 nm to 100 nm improves UV reflection but degrades total solar reflection performance due to their high absorption. However, using moderate to large particle sizes, 150 nm to 600 nm, generates the broadest reflection peak over the section of the solar spectrum with the highest intensities.

### Performance Test of PDRC Coatings Under the Relevant Environment

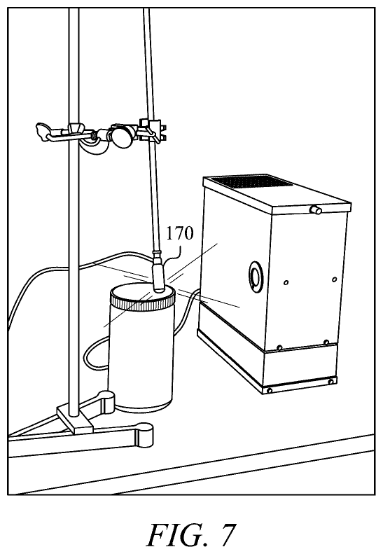

The radiative cooling paints were tested for their ability to reflect visible light as well as near-infrared light using a solar illuminator. A solar illuminator replicates the spectral characteristics and intensity of sunlight. In FIG. 7, a solar illuminator producing the spectrum AM1.5G is preferably used to test the radiative paint samples, wherein the light source (170) is a xenon arc lamp. AM1.5G is the spectrum generally used in terrestrial solar research. The xenon arc lamp produces a broad spectrum of light that closely mimics the natural sunlight. The solar simulator further includes an air mass filter that provides a light spectrum corresponding to the conditions at a solar zenith angle of 48.2 degrees. The light spectrum so produced includes both direct sunlight and diffused sky radiations. The solar illuminator further includes optical components to control the intensity and uniformity of the light. Thus, the controlled environment provided by the illuminator can be utilized to assess the performance of samples in a similar way as in the case of natural sunlight conditions.

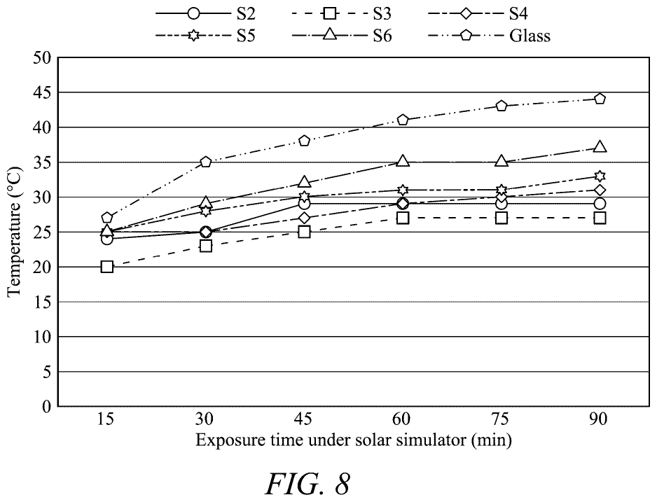

To test the performance of the PDRC formulations under the relevant environment of solar exposure, each sample was coated on glass vials and dried at room temperature for 24 hours under a clean-covered atmosphere. The PDRC-coated vials with inserted and sealed thermometers were placed under the solar simulator (AM1.5G), and temperature data was recorded at 15, 30, 45, 60, 75, and 90-minute intervals. As shown in FIG. 8, the test results of the BaSO₄ coatings (S2-S6) performed significantly better than those of commercial white paint. After 90 minutes of irradiating the samples under a solar simulator, the uncoated glass reached 44° C., and the commercial sample reached 37° C. However, the S3 coated sample has outperformed and reached only 27° C. A temperature performance comparison of various formulations, as depicted in FIG. 8, indicates that the substantial scattering shown by formulation S3 is attributed to a unique combination of BaSO₄ pigment having a broad size distribution.

A first embodiment describes a sprayable radiative cooling paint including about 25 wt. % polyacrylic binder, about 50 wt. % deionized water, and about 25 wt. % BaSO₄ particles having a plurality of hydrodynamic size distributions between about 45 nm to about 1,650 nm as determined by dynamic light scattering (DLS) measurements, wherein a first hydrodynamic size distribution has an average particle size from 1,600 nm to 1,650 nm, a second hydrodynamic size distribution has an average particle size from 300 nm to 350 nm, a third hydrodynamic size distribution has an average particle size from about 175 nm to 190 nm, a fourth hydrodynamic size distribution has an average particle size from 145 nm to 160 nm, a fifth hydrodynamic size distribution has an average particle size from 130 nm to 140 nm and a sixth hydrodynamic size distribution has an average particle size from 45 nm to 60 nm, wherein wt. % is based on a total weight of the sprayable radiative cooling paint.

In an aspect, the BaSO₄ particles have an average particle size of about 183 nm.

In an aspect, a solar reflectance of a dried coating formed from the sprayable radiative cooling paint is about 90%.

In an aspect, the first hydrodynamic size distribution has an average particle size of about 1638 nm, the second hydrodynamic size distribution has an average particle size of about 326 nm formed by ball milling the BaSO₄ particles for about two hours, the third hydrodynamic size distribution has an average particle size of about 183 nm formed by ball milling the BaSO₄ particles for about six hours, the fourth hydrodynamic size distribution has an average particle size of about 151 nm formed by ball milling the BaSO₄ particles for about ten hours, the fifth hydrodynamic size distribution has an average particle size of about 137 nm formed by ball milling the BaSO₄ particles for about twenty-four hours, and the sixth hydrodynamic size distribution has an average particle size of about 53 nm formed by ball milling the BaSO₄ particles for about forty-eight hours.

In an aspect, a formulation (S2) includes about 25 wt. % of BaSO₄ particles having the first hydrodynamic size distribution with an average particle size of about 1638 nm.

In an aspect, a temperature of a surface coated with the sprayable radiative cooling paint and exposed to solar radiation for about one hour is about 29° C.; and a maximum solar reflectance of an infrared light of a dried coating formed from the sprayable radiative cooling paint is about 80%.

In an aspect, a formulation (S3) includes about 4.16 wt. % of BaSO₄ particles having the first hydrodynamic size distribution with an average particle size of about 1638 nm, about 4.16 wt. % of BaSO₄ particles having the second hydrodynamic size distribution with an average particle size of about 326 nm, about 4.16 wt. % of BaSO₄ particles having the third hydrodynamic size distribution with an average particle size of about 183 nm, about 4.16 wt. % of BaSO₄ particles having the fourth hydrodynamic size distribution with an average particle size of about 151 nm, about 4.16 wt. % of BaSO₄ particles having the fifth hydrodynamic size distribution with an average particle size of about 137 nm, and about 4.16 wt. % of BaSO₄ particles having the sixth hydrodynamic size distribution with an average particle size of about 53 nm.

In an aspect, a temperature of a surface coated with the sprayable radiative cooling paint and exposed to solar radiation for about one hour is about 27° C.; and a maximum solar reflectance of an infrared light of a dried coating formed from the sprayable radiative cooling paint is about 98%.

In an aspect, a formulation (S4) contains about 6.24 wt. % of BaSO₄ particles having the first hydrodynamic size distribution with an average particle size of about 1638 nm, about 6.24 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 2.08 wt. % of BaSO₄ particles having the fourth hydrodynamic particle size of about 151 nm, about 2.08 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm.

In an aspect, a temperature of a surface coated with the sprayable radiative cooling paint and exposed to solar radiation for about one hour is about 29° C.; and a maximum solar reflectance of an infrared light of a dried coating formed from the sprayable radiative cooling paint is greater than about 90%.

In an aspect, a formulation (S5) contains about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 2.08 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 6.24 wt. % of BaSO₄ particles having the sixth hydrodynamic size distribution with an average particle size of about 53 nm.

In an aspect, a temperature of a surface coated with the sprayable radiative cooling paint and exposed to solar radiation for about one hour is about 31° C.; and a maximum solar reflectance of an infrared light of a dried coating formed from the sprayable radiative cooling paint is about 90%.

In an aspect, a formulation (S6) contains about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm.

In an aspect, a temperature of a surface coated with the sprayable radiative cooling paint and exposed to solar radiation for about one hour is about 35° C.; and a maximum solar reflectance of an infrared light of a dried coating formed from the sprayable radiative cooling paint is about 80%.

A second embodiment describes a method of making a sprayable radiative cooling paint. The method includes obtaining a first quantity of BaSO₄ powder having a hydrodynamic size distribution with an average particle size of about 1638 nm, grinding, in a ball milling machine, a second quantity of BaSO₄ powder for about two hours until the second quantity has a second hydrodynamic size distribution with an average particle size of about 326 nm, grinding, in a ball milling machine, a third quantity of BaSO₄ powder for about six hours until the third quantity has a third hydrodynamic size distribution with an average particle size of about 183 nm, grinding, in a ball milling machine, a fourth quantity of BaSO₄ powder for about ten hours the fourth quantity has a fourth hydrodynamic size distribution with an average particle size of about 151 nm, grinding, in a ball milling machine, a fifth quantity of BaSO₄ powder for about twenty-four hours until the fifth quantity has a fifth hydrodynamic size distribution with an average particle size of about 137 nm, grinding, in a ball milling machine, a sixth quantity of BaSO₄ powder for about forty-eight hours until the sixth quantity has a sixth hydrodynamic size distribution with an average particle size of about 53 nm is obtained, and forming a first sprayable radiative cooling paint, a second sprayable radiative cooling paint, a third sprayable radiative cooling paint, a fourth sprayable radiative cooling paint and a fifth sprayable radiative cooling paint by mixing, in a mixer, in an amount of about 25 wt. %, combinations of each of the first quantity of BaSO₄ powder, the second quantity, the third quantity, the fourth quantity, the fifth quantity and the sixth quantity, respectively, with about 25 wt. % of polyacrylic binder and about 50 wt. % of deionized water, ultrasonicating, in an ultrasonicator, each sprayable radiative cooling paint and mixing, by a roller mixer, each sprayable radiative cooling paint for about twenty-four hours.

In an aspect, the first sprayable radiative cooling paint comprises 25 wt. % of the first quantity of BaSO₄ powder having a hydrodynamic size distribution with an average particle size of about 1638 nm, a temperature of a surface coated with the first sprayable radiative cooling paint and exposed to solar radiation for about one hour is about 29° C., and a maximum solar reflectance of an infrared light of a dried coating formed from the first sprayable radiative cooling paint is about 80%.

In an aspect, the second sprayable radiative cooling paint comprises about 4.16 wt. % of BaSO₄ particles having the second hydrodynamic size distribution with an average particle size of about 326 nm, about 4.16 wt. % of BaSO₄ particles having the third hydrodynamic size distribution with an average particle size of about 183 nm, about 4.16 wt. % of BaSO₄ particles having the fourth hydrodynamic size distribution with an average particle size of about 151 nm, about 4.16 wt. % of BaSO₄ particles having the fifth hydrodynamic size distribution with an average particle size of about 137 nm, and about 4.16 wt. % of BaSO₄ particles having the sixth hydrodynamic size distribution with an average particle size of about 53 nm, a temperature of a surface coated with the sprayable radiative cooling paint and exposed to solar radiation for about one hour is about 27° C., and a maximum solar reflectance of an infrared light of a dried coating formed from the sprayable radiative cooling paint is about 98%.

In an aspect, the third sprayable radiative cooling paint comprises about 6.24 wt. % of BaSO₄ particles having the first hydrodynamic size distribution with an average particle size of about 1638 nm, about 6.24 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 2.08 wt. % of BaSO₄ particles having the fourth hydrodynamic size distribution with an average particle size of about 151 nm, about 2.08 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm, a temperature of a surface coated with the sprayable radiative cooling paint and exposed to solar radiation for about one hour is about 29° C., and a maximum solar reflectance of an infrared light of a dried coating formed from the sprayable radiative cooling paint is greater than about 90%.

In an aspect, the fourth sprayable radiative cooling paint comprises about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 2.08 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 6.24 wt. % of BaSO₄ particles having the sixth hydrodynamic size distribution with an average particle size of about 53 nm, a temperature of a surface coated with the sprayable radiative cooling paint and exposed to solar radiation for about one hour is about 31° C., and a maximum solar reflectance of an infrared light of a dried coating formed from the sprayable radiative cooling paint is about 90%.

In an aspect, the fifth sprayable radiative cooling paint comprises about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm, a temperature of a surface coated with the sprayable radiative cooling paint and exposed to solar radiation for about one hour is about 35° C., and a maximum solar reflectance of an infrared light of a dried coating formed from the sprayable radiative cooling paint is about 80%.

### Cost Analysis of PDRC Coating

BaSO₄ is available in the natural mineral barite, commonly used as a radiocontrast agent, a paper brightener, and a significant element in cosmetic products. BaSO₄ powder is about half the price of TiO₂ powder ($1 per kilogram), costing approximately $0.44 per kilogram [See: S. D. Gedzelman, Optics, Atmospheric|Optical Phenomena, in: Encycl. Atmos. Sci., Elsevier, 2003: pp. 1583-1594.]. The BaSO₄ fillers cost around $100 for a 150 m² house with a 30 degree roof angle and a 300 μm paint thickness. Therefore, BaSO₄-based paint can be priced similarly to commercial white paint because of a similar production technique.

The top-down milling method was used to optimize a sprayable radiative cooling paint formalization to achieve maximum light scattering with different sizes of BaSO₄ particles. Additionally, ball milling results showed that increased time from 0-48 hours resulted in a decline in the particle size distribution. DLS analysis of each sample ranges the hydrodynamic size distribution from ~1.82 μM to <50 nm. Further, XRD results showed that the decline in particle size resulted in the enhancement of peak broadness. The same tendency of size decrease was observed from the FESEM analyses of representative samples milled for 0 h, 2 h, 24 h, and 48 h. By adopting an appropriate particle size and a broad particle size distribution, a high solar reflectance of >98% can be achieved.

Various sizes of BaSO₄ NPs were mixed with polyacrylic binder and deionized water to prepare different paint formulations to achieve the best scattering. This is validated by the observation that BaSO₄-based coatings with variable particle sizes and commercial paint showed significant changes in temperatures. The uncoated glass reached 43° C.; however, sample S3 of the formulated coating reached 26° C., and the commercial paint alone reached 35° C.

The PDRC coatings of the present disclosure are scalable and can be prepared on a large industrial scale as the raw materials required for their preparation are very common, easily accessible, and inexpensive. The cost analysis of raw materials was established following a market assessment. The produced PDRC coating offers excellent potential for industrial-scale manufacturing.

Numerous modifications and variations of the present disclosure are possible in light of the above teachings. It is therefore to be understood that within the scope of the appended claims, the invention may be practiced otherwise than as specifically described herein.

1. A sprayable radiative cooling paint, comprising:
about 25 wt. % polyacrylic binder;
about 50 wt. % deionized water; and
about 25 wt. % BaSO₄ particles having a plurality of hydrodynamic size distributions between about 45 nm to about 1,650 nm as determined by dynamic light scattering (DLS) measurements, wherein a first hydrodynamic size distribution has an average particle size from 1,600 nm to 1,650 nm, a second hydrodynamic size distribution has an average particle size from 300 nm to 350 nm, a third hydrodynamic size distribution has an average particle size from about 175 nm to 190 nm, a fourth hydrodynamic size distribution has an average particle size from 145 nm to 160 nm, a fifth hydrodynamic size distribution has an average particle size from 130 nm to 140 nm and a sixth hydrodynamic size distribution has an average particle size from 45 nm to 60 nm,
wherein wt. % is based on a total weight of the sprayable radiative cooling paint.

2. The sprayable radiative cooling paint of claim 1, wherein the BaSO₄ particles have an average particle size of about 183 nm.

3. The sprayable radiative cooling paint of claim 1, wherein a solar reflectance of a dried coating formed from the sprayable radiative cooling paint is about 90%.

4. The sprayable radiative cooling paint of claim 1, wherein:
the first hydrodynamic size distribution has an average particle size of about 1638 nm;
the second hydrodynamic size distribution has an average particle size of about 326 nm formed by ball milling the BaSO₄ particles for about two hours;
the third hydrodynamic size distribution has an average particle size of about 183 nm formed by ball milling the BaSO₄ particles for about six hours;
the fourth hydrodynamic size distribution has an average particle size of about 151 nm formed by ball milling the BaSO₄ particles for about ten hours;
the fifth hydrodynamic size distribution has an average particle size of about 137 nm formed by ball milling the BaSO₄ particles for about twenty-four hours; and
the sixth hydrodynamic size distribution has an average particle size of about 53 nm formed by ball milling the BaSO₄ particles for about forty-eight hours.

5. The sprayable radiative cooling paint of claim 4, having a formulation comprising:
about 25 wt. % of BaSO₄ particles having the first hydrodynamic size distribution with an average particle size of about 1638 nm.

6. The sprayable radiative cooling paint of claim 5, wherein:
a temperature of a surface coated with the sprayable radiative cooling paint and exposed to solar radiation for about one hour is about 29° C.; and
a maximum solar reflectance of an infrared light of a dried coating formed from the sprayable radiative cooling paint is about 80%.

7. The sprayable radiative cooling paint of claim 4, having a formulation comprising:
about 4.16 wt. % of BaSO₄ particles having the first hydrodynamic size distribution with an average particle size of about 1638 nm,
about 4.16 wt. % of BaSO₄ particles having the second hydrodynamic size distribution with an average particle size of about 326 nm,
about 4.16 wt. % of BaSO₄ particles having the third hydrodynamic size distribution with an average particle size of about 183 nm,
about 4.16 wt. % of BaSO₄ particles having the fourth hydrodynamic size distribution with an average particle size of about 151 nm,
about 4.16 wt. % of BaSO₄ particles having the fifth hydrodynamic size distribution with an average particle size of about 137 nm, and
about 4.16 wt. % of BaSO₄ particles having the sixth hydrodynamic size distribution with an average particle size of about 53 nm.

8. The sprayable radiative cooling paint of claim 7, wherein:
a temperature of a surface coated with the sprayable radiative cooling paint and exposed to solar radiation for about one hour is about 27° C.; and
a maximum solar reflectance of an infrared light of a dried coating formed from the sprayable radiative cooling paint is about 98%.

9. The sprayable radiative cooling paint of claim 4, having a formulation comprising:
about 6.24 wt. % of BaSO₄ particles having the first hydrodynamic size distribution with an average particle size of about 1638 nm,
about 6.24 wt. % of BaSO₄ particles having the second hydrodynamic size distribution with an average particle size of about 326 nm,
about 6.24 wt. % of BaSO₄ particles having the third hydrodynamic size distribution with an average particle size of about 183 nm,
about 2.08 wt. % of BaSO₄ particles having the fourth hydrodynamic particle size of about 151 nm,
about 2.08 wt. % of BaSO₄ particles having the fifth hydrodynamic size distribution with an average particle size of about 137 nm, and
about 2.08 wt. % of BaSO₄ particles having the sixth hydrodynamic size distribution with an average particle size of about 53 nm.

10. The sprayable radiative cooling paint of claim 9, wherein:
a temperature of a surface coated with the sprayable radiative cooling paint and exposed to solar radiation for about one hour is about 29° C.; and
a maximum solar reflectance of an infrared light of a dried coating formed from the sprayable radiative cooling paint is greater than about 90%.

11. The sprayable radiative cooling paint of claim 4, having a formulation comprising:
about 2.08 wt. % of BaSO₄ particles having the first hydrodynamic size distribution with an average particle size of about 1638 nm,
about 2.08 wt. % of BaSO₄ particles having the second hydrodynamic size distribution with an average particle size of about 326 nm,
about 2.08 wt. % of BaSO₄ particles having the third hydrodynamic size distribution with an average particle size of about 183 nm,
about 6.24 wt. % of BaSO₄ particles having the fourth hydrodynamic size distribution with an average particle size of about 151 nm,
about 6.24 wt. % of BaSO₄ particles having the fifth hydrodynamic size distribution with an average particle size of about 137 nm, and
about 6.24 wt. % of BaSO₄ particles having the sixth hydrodynamic size distribution with an average particle size of about 53 nm.

12. The sprayable radiative cooling paint of claim 11, wherein:
a temperature of a surface coated with the sprayable radiative cooling paint and exposed to solar radiation for about one hour is about 31° C.; and
a maximum solar reflectance of an infrared light of a dried coating formed from the sprayable radiative cooling paint is about 90%.

13. The sprayable radiative cooling paint of claim 4, having a formulation comprising:
about 2.08 wt. % of BaSO₄ particles having the first hydrodynamic size distribution with an average particle size of about 1638 nm,
about 2.08 wt. % of BaSO₄ particles having the second hydrodynamic size distribution with an average particle size of about 326 nm,
about 6.24 wt. % of BaSO₄ particles having the third hydrodynamic size distribution with an average particle size of about 183 nm,
about 6.24 wt. % of BaSO₄ particles having the fourth hydrodynamic size distribution with an average particle size of about 151 nm,
about 6.24 wt. % of BaSO₄ particles having the fifth hydrodynamic size distribution with an average particle size of about 137 nm, and
about 2.08 wt. % of BaSO₄ particles having the sixth hydrodynamic size distribution with an average particle size of about 53 nm.

14. The sprayable radiative cooling paint of claim 13, wherein:
a temperature of a surface coated with the sprayable radiative cooling paint and exposed to solar radiation for about one hour is about 35° C.; and
a maximum solar reflectance of an infrared light of a dried coating formed from the sprayable radiative cooling paint is about 80%.

15. A method of making a sprayable radiative cooling paint, comprising:
obtaining a first quantity of BaSO₄ powder having a hydrodynamic size distribution with an average particle size of about 1638 nm;
grinding, in a ball milling machine, a second quantity of BaSO₄ powder for about two hours until the second quantity has a second hydrodynamic size distribution with an average particle size of about 326 nm;
grinding, in a ball milling machine, a third quantity of BaSO₄ powder for about six hours until the third quantity has a third hydrodynamic size distribution with an average particle size of about 183 nm;
grinding, in a ball milling machine, a fourth quantity of BaSO₄ powder for about ten hours the fourth quantity has a fourth hydrodynamic size distribution with an average particle size of about 151 nm;
grinding, in a ball milling machine, a fifth quantity of BaSO₄ powder for about twenty-four hours until the fifth quantity has a fifth hydrodynamic size distribution with an average particle size of about 137 nm;
grinding, in a ball milling machine, a sixth quantity of BaSO₄ powder for about forty-eight hours until the sixth quantity has a sixth hydrodynamic size distribution with an average particle size of about 53 nm is obtained; and
forming a first sprayable radiative cooling paint, a second sprayable radiative cooling paint, a third sprayable radiative cooling paint, a fourth sprayable radiative cooling paint and a fifth sprayable radiative cooling paint by mixing, in a mixer, in an amount of about 25 wt. %, combinations of each of the first quantity of BaSO₄ powder, the second quantity, the third quantity, the fourth quantity, the fifth quantity and the sixth quantity, respectively, with about 25 wt. % of polyacrylic binder and about 50 wt. % of deionized water, ultrasonicating, in an ultrasonicator, each sprayable radiative cooling paint and mixing, by a roller mixer, each sprayable radiative cooling paint for about twenty-four hours.

16. The method of claim 15, wherein:
the first sprayable radiative cooling paint comprises 25 wt. % of the first quantity of BaSO₄ powder having a hydrodynamic size distribution with an average particle size of about 1638 nm;
a temperature of a surface coated with the first sprayable radiative cooling paint and exposed to solar radiation for about one hour is about 29° C.; and
a maximum solar reflectance of an infrared light of a dried coating formed from the first sprayable radiative cooling paint is about 80%.

17. The method of claim 15, wherein:
the second sprayable radiative cooling paint comprises about 4.16 wt. % of BaSO₄ particles having the second hydrodynamic size distribution with an average particle size of about 326 nm, about 4.16 wt. % of BaSO₄ particles having the third hydrodynamic size distribution with an average particle size of about 183 nm, about 4.16 wt. % of BaSO₄ particles having the fourth hydrodynamic size distribution with an average particle size of about 151 nm, about 4.16 wt. % of BaSO₄ particles having the fifth hydrodynamic size distribution with an average particle size of about 137 nm, and about 4.16 wt. % of BaSO₄ particles having the sixth hydrodynamic size distribution with an average particle size of about 53 nm;
a temperature of a surface coated with the sprayable radiative cooling paint and exposed to solar radiation for about one hour is about 27° C.; and
a maximum solar reflectance of an infrared light of a dried coating formed from the sprayable radiative cooling paint is about 98%.

18. The method of claim 15, wherein:
the third sprayable radiative cooling paint comprises about 6.24 wt. % of BaSO₄ particles having the first hydrodynamic size distribution with an average particle size of about 1638 nm, about 6.24 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 2.08 wt. % of BaSO₄ particles having the fourth hydrodynamic size distribution with an average particle size of about 151 nm, about 2.08 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm;
a temperature of a surface coated with the sprayable radiative cooling paint and exposed to solar radiation for about one hour is about 29° C.; and
a maximum solar reflectance of an infrared light of a dried coating formed from the sprayable radiative cooling paint is greater than about 90%.

19. The method of claim 15, wherein:
the fourth sprayable radiative cooling paint comprises about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 2.08 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 6.24 wt. % of BaSO₄ particles having the sixth hydrodynamic size distribution with an average particle size of about 53 nm;
a temperature of a surface coated with the sprayable radiative cooling paint and exposed to solar radiation for about one hour is about 31° C.; and
a maximum solar reflectance of an infrared light of a dried coating formed from the sprayable radiative cooling paint is about 90%.

20. The method of claim 16, wherein:
the fifth sprayable radiative cooling paint comprises about 2.08 wt. % of BaSO₄ particles having the first hydrodynamic size distribution with an average particle size of about 1638 nm, about 2.08 wt. % of BaSO₄ particles having the second hydrodynamic size distribution with an average particle size of about 326 nm, about 6.24 wt. % of BaSO₄ particles having the third hydrodynamic size distribution with an average particle size of about 183 nm, about 6.24 wt. % of BaSO₄ particles having the fourth hydrodynamic size distribution with an average particle size of about 151 nm, about 6.24 wt. % of BaSO₄ particles having the fifth hydrodynamic size distribution with an average particle size of about 137 nm, and about 2.08 wt. % of BaSO₄ particles having the sixth hydrodynamic size distribution with an average particle size of about 53 nm;
a temperature of a surface coated with the sprayable radiative cooling paint and exposed to solar radiation for about one hour is about 35° C.; and
a maximum solar reflectance of an infrared light of a dried coating formed from the sprayable radiative cooling paint is about 80%.
